(19) United States
(12) Patent Application Publication
(10) Pub. No.: US 2014/0002461 A1
(43) Pub. Date: Jan. 2, 2014

(54) Environmental Controller Displays

(71) Applicant: EMERSON ELECTRIC CO., St.louis, MO (US)

(72) Inventor: Dong Wang, Xi'an (CN)

(73) Assignee: EMERSON ELECTRIC CO., St. Louis, MO (US)

(21) Appl. No.: 13/792,366

(22) Filed: Mar. 11, 2013

(30) Foreign Application Priority Data
Jun. 27, 2012 (CN) 201210215853.8

(51) Int. Cl. G06T 11/20

(52) U.S. Cl. CPC G06T 11/206
USPC 345/440

(57) ABSTRACT

Exemplary embodiments are disclosed of an environmental controller having a processor and memory configured to, in an environmental control cycle of the controller, receive, in substantially real time, sensor data indicating operational values of at least one parameter controlled through the controller based on a control schedule for the control cycle. The processor(s) and memory are configured to graphically display, in substantially real time, the operational values and the control schedule relative to a time line for the control cycle.

### CROSS-REFERENCE TO RELATED APPLICATION

This application claims the benefit and priority of Chinese Patent of Invention Application No. 201210215853.8, filed Jun. 27, 2012. The entire disclosure of the above application is incorporated herein by reference.

### FIELD

The present disclosure relates to environmental controller displays.

### BACKGROUND

This section provides background information related to the present disclosure which is not necessarily prior art.

In most commonly used systems for curing tobacco and other materials, a controller may include a display that provides users with basic information, e.g., describing temperature and set-point. Thermostats in heating, ventilating and air conditioning (HVAC) systems may provide displays of the same or similar information to users.

### SUMMARY

This section provides a general summary of the disclosure, and is not a comprehensive disclosure of its full scope or all of its features.

Exemplary embodiments are disclosed of an environmental controller comprising at least one processor and memory configured to, in an environmental control cycle of the controller, receive, in substantially real time, sensor data indicating operational values of at least one parameter controlled through the controller based on a control schedule for the control cycle. The processor(s) and memory are configured to graphically display, in substantially real time, the operational values and the control schedule relative to a time line for the control cycle.

Exemplary embodiments are also disclosed of an environmental controller comprising at least one processor and memory configured to, in an environmental control cycle of the controller, receive, in substantially real time, sensor data indicating operational values of at least one parameter controlled through the controller. The processor(s) and memory are configured to graphically display, in substantially real time, the operational values relative to a time line for the control cycle, and graphically display and move a time indicator along the time line substantially in real time to indicate time relative to a start of the control cycle.

Exemplary embodiments also are disclosed of an environmental controller comprising at least one processor and memory configured to graphically display a time line for an environmental control cycle of the controller. Based on user input, the processor(s) selectively display, graphically and relative to the time line: (a) a control schedule for controlling at least one parameter in accordance with one or more control values for the control cycle, and/or (b) substantially real-time operational values of the parameter(s).

Exemplary embodiments also are disclosed of methods of controlling screen displays. In an exemplary embodiment, a method generally includes receiving, in substantially real time, sensor data indicating operational values of at least one parameter based on a control schedule for an environmental control cycle of an environmental controller. The example method also includes graphically displaying, in substantially real time, the operational values and the control schedule relative to a time line for the control cycle. The example method further includes graphically displaying and moving a time indicator along the time line substantially in real time to indicate time relative to a start of the control cycle.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagram of an environmental controller and display screens in accordance with an exemplary embodiment of the disclosure;

FIG. 2 is a diagram of a hardware configuration for an environmental controller in accordance with an exemplary embodiment of the disclosure;

FIG. 3A is an illustration of an operation screen of a material curing system controller in accordance with an exemplary embodiment of the disclosure;

FIG. 3B is an illustration of an operation screen of a HVAC thermostat in accordance with an exemplary embodiment of the disclosure;

FIG. 4 is a flow diagram of a method of controlling display of an operation screen in accordance with an exemplary embodiment of the disclosure;

FIG. 5A is an illustration of a set-point screen of a material curing system controller in accordance with an exemplary embodiment of the disclosure;

FIG. 5B is an illustration of a set-point screen of a HVAC thermostat in accordance with an exemplary embodiment of the disclosure;

FIG. 6 is a flow diagram of a method of controlling display of a set-point screen in accordance with an exemplary embodiment of the disclosure;

FIG. 7 is a flow diagram of a method of controlling display of a status screen in accordance with an exemplary embodiment of the disclosure;

FIG. 8 is an illustration of a comparison screen of a material curing system controller in accordance with an exemplary embodiment of the disclosure;

FIG. 9A is an illustration of a temperature trend screen of a HVAC thermostat in accordance with an exemplary embodiment of the disclosure; and

FIG. 9B is an illustration of a humidity trend screen of a HVAC thermostat in accordance with an exemplary embodiment of the disclosure.

### DETAILED DESCRIPTION

Example embodiments will now be described more fully with reference to the accompanying drawings.

For some environmental control applications, for example, when using a curing system for tobacco or other materials, a user may not only want to set the system to one or more desired temperatures, but the user also may want to keep track of operating conditions and trends of an entire curing cycle. The inventor hereof has observed that environmental controllers currently used in tobacco curing applications typically do not show the current trending of an actual curing cycle.

Accordingly, in various exemplary aspects of the disclosure, an environmental controller is provided that receives, in substantially real time in an environmental control cycle, sensor data indicating operational values of at least one parameter, such as temperature, humidity, oxygen, carbon dioxide, concentration of oxygen relative to carbon dioxide, and/or light intensity, controlled through the controller based on a control schedule for the control cycle. Based on user input, the controller may graphically display, in substantially real time, the operational values and/or the control schedule relative to a time line for the control cycle. The controller also may graphically display and move a time indicator in substantially real time relative to the time line, e.g., to display the real-time progress of the control cycle. Various exemplary embodiments of environmental controllers may be provided in accordance with aspects of the disclosure for use in various types of environmental control systems, including but not limited to material curing systems and HVAC systems.

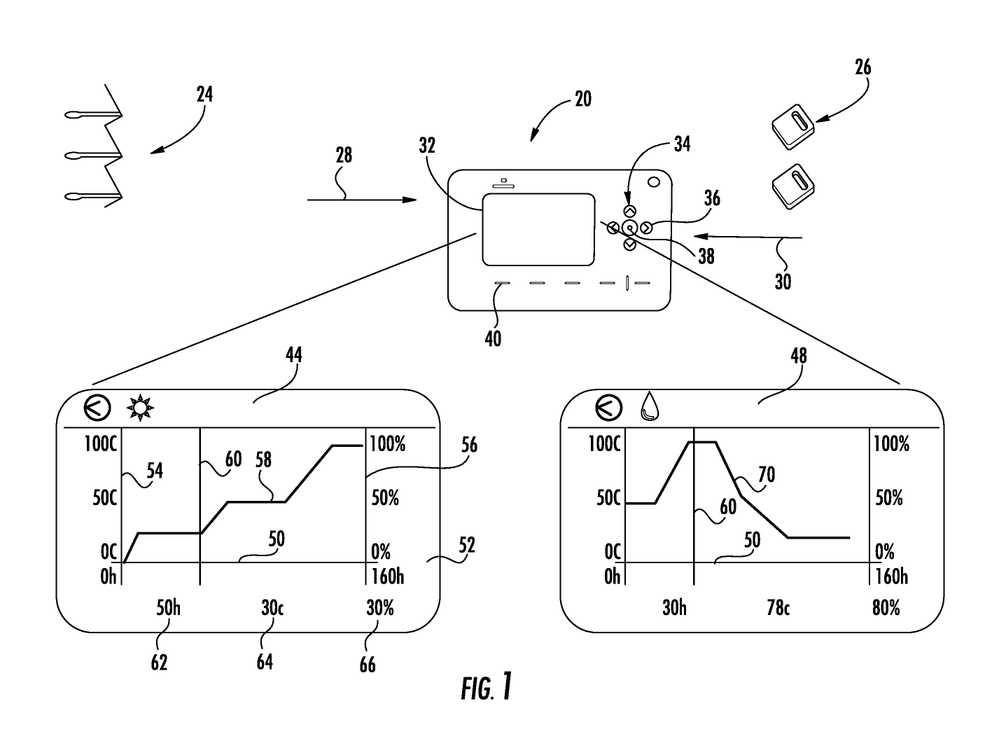

With reference now to the figures, FIG. 1 illustrates an exemplary environmental controller 20 embodying one or more aspects of the present disclosure. The controller 20 is configured for use, e.g., in a tobacco curing environment. Various exemplary embodiments may be provided, however, for curing other or additional materials and/or for controlling heating, ventilation and/or cooling systems that are not used in curing applications.

The controller 20 includes a power source (e.g., one or more batteries, etc.) and may communicate with one or more temperature sensors 24 and one or more humidity sensors 26. The sensors 24 and 26 may be remote from the controller 20. In other exemplary embodiments, the controller may additionally or alternatively communicate with one or more oxygen sensors, carbon dioxide sensors, and/or light intensity sensors. In the present example embodiment, each of three (3) remote temperature sensors 24 is connected with the controller 20, e.g., by a corresponding link or line 28. Two remote humidity sensors 26 are connected with the controller 20, e.g., via an I2C bus 30. But in various environmental controller embodiments, temperature sensors 24 and/or humidity sensors 26 may be wired, wireless, analog, digital, and/or various combinations thereof.

The controller 20 includes a user interface including a display 32 (e.g., a liquid crystal display (LCD), etc.), and keys or buttons generally referred to by reference number 34. By way of example and as further described below, the display 32 may display a graph representing a drying cycle for the material drying system, the parameters of which may be modifiable or changed by a user. For example, directional keys 36 may be operable to allow a user to navigate around the display 32 to highlight different features displayed on the display 32. A middle or center key 38 may enable selection of a highlighted feature. Directional keys 36 may be operable for incrementally increasing or decreasing a highlighted parameter for the drying cycle, such as temperature, humidity, duration, etc., for advancing to or moving back from a selected screen, for selecting a particular screen location, etc. A row of keys or buttons 40 may be used, e.g., for programming the controller 20 and for making various selections as further described below.

The functions of keys 40 may change according to menu-driven programming. In use, the keys 40 may, for example, allow the user to select, set, or change parameters of a drying cycle such as process temperature, humidity, duration, etc., for drying the material. Other exemplary embodiments may include a controller having a different menu structure (e.g., keys that allow a user to select a particular type of tobacco leaf or other material to be dried, etc.) and/or include a different configuration (e.g., different control keys, different control key arrangement, different display, etc.) than what is shown in FIG. 1. For example, an alternative embodiment may include the display device 32 and keys 34, 40 as part of a touchscreen display, etc.

The controller 20 may display, e.g., dot matrix displays of information on the display 32, including but not limited to information based on data from the temperature and humidity sensors 24 and 26. For example, when the controller 20 is in operation, a user may selectively view a status display screen 44 that graphically displays temperature and/or a status display screen 48 that graphically displays relative humidity. On the screens 44 and 48, a time line 50 is displayed for an environmental control cycle 52 of the controller, which in the present example extends from 0 hours to 160 hours. A left-hand axis 54 indicates temperature in degrees Celsius. A right-hand axis 56 indicates relative humidity. In the example display screen 44, operational values 58 from temperature sensors 24 are received and graphically displayed (e.g., as a control curve, etc.), substantially in real time, relative to the time line 50. In the example display screen 48, operational values 58 from humidity sensors 26 are received and graphically displayed, substantially in real time, relative to the time line 50.

The controller 20 graphically displays and may move, e.g., substantially in real time, a time indicator 60 relative to the time line 50, e.g., along and/or across the time line 50. The time indicator 60 thus may graphically indicate the current time relative to start of the control cycle 52. Additionally, current status information is also shown, including time shown in an area 62, current temperature shown in an area 64, and current relative humidity shown in an area 66. The display screen 44 also includes an icon of a sun to indicate that temperature data is being graphically displayed, and also provides the current time as 50 hours (50 h) that has passed along the time line 50, current temperature as 30 degrees Celsius. (30 c), and current relative humidity as 30%. The example display screen 48 includes an icon of a drop of water to indicate that relative humidity data is being graphically displayed, and also provides the current time as 30 hours (30 h) that has passed along the time line, current temperature as 78 degrees Celsius (78 c), and current relative humidity as 80%. The display screens 44 and 48 may also include an appropriate title at the top or elsewhere in the display screen, such as Curve of Temperature Operation and Curve of Humidity Operation, etc.

Additionally or alternatively, a user may wish to move the time indicator 60, e.g., to the left or right to a selected location relative to the time line 50, in order to view information corresponding to a particular time in the control cycle. Thus, in response to user input, the controller 20 may graphically display and move the time indicator 60 to a user-selected location relative to the time line 50. In such case, the areas 62, 64, and 66 show time, temperature, and humidity information corresponding to the location of the time indicator 60. In some exemplary embodiments, on a time line and/or in other information areas of a display screen, time may be expressed without reference to a control cycle and instead, e.g., relative to a time zone in which the controller is located.

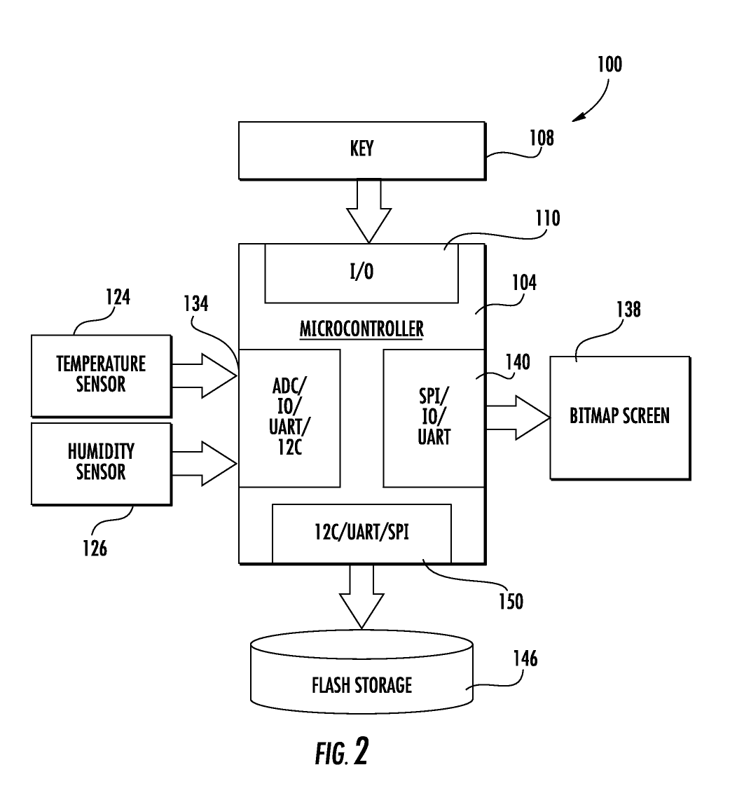

FIG. 2 illustrates an exemplary embodiment of a hardware configuration 100 for an environmental controller. A processor, e.g., a microcontroller 104, receives key input 108 through an input/output (I/O) interface 110. The microcontroller 104 may communicate with, e.g., temperature sensor(s) 124 and/or humidity sensor(s) 126 via various interfaces 134, e.g., analog/digital converter(s), digital input/output (I/O), universal asynchronous receiver/transmitter (UART), and/or I2C and other or additional bus(ses). The microcontroller 104 may also produce a bitmap display screen 138 via various interfaces 140, e.g., serial peripheral interface (SPI), digital I/O, and/or UART. The microcontroller 104 accesses data storage, e.g., one or more flash storage devices or memory 146, via various interfaces 150, e.g., bus(ses), UART, and/or SPI. The microcontroller 104 stores in the memory 146 temperature and humidity data received from the sensors 124, 126 along with time data as further described below.

In various exemplary embodiments of the disclosure and based on user input, an environmental controller may display, relative to a time line, e.g., a programmed schedule for control of such parameters as temperature (e.g., heating or cooling) and/or humidity. The controller may display a curve or other graphic representation of, e.g., control value(s) for temperature or relative humidity scheduled, e.g., over an entire control cycle.

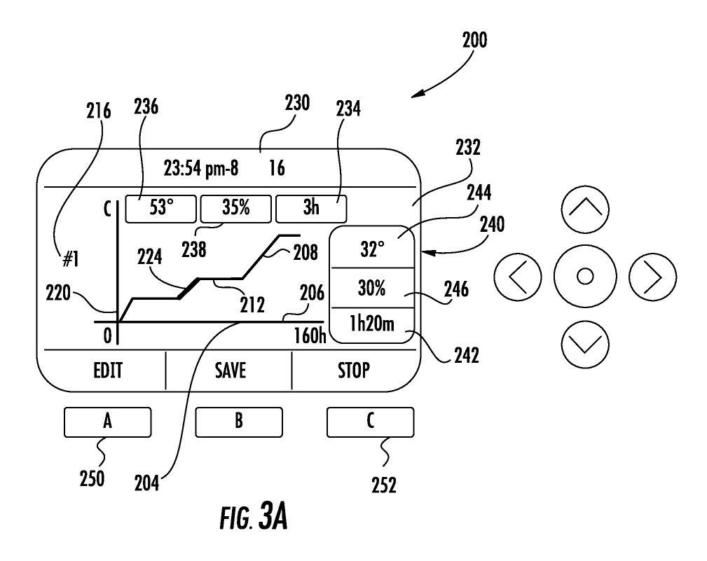

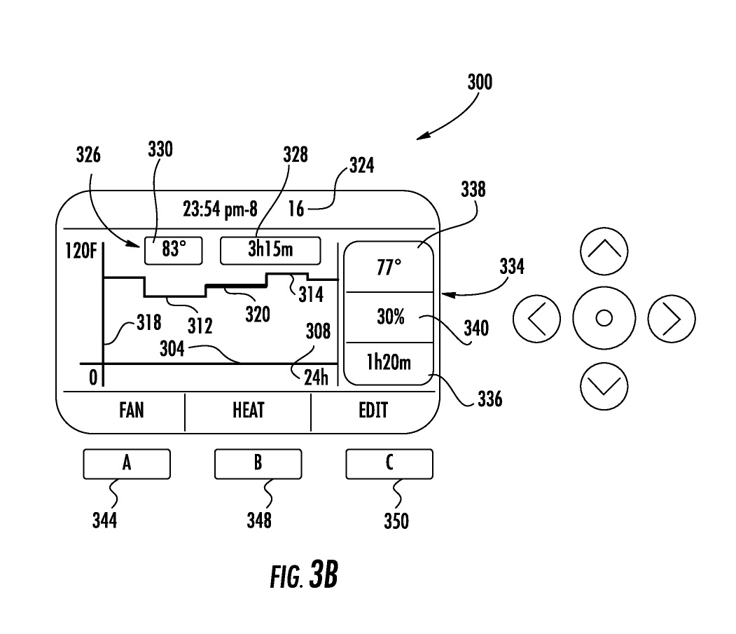

FIG. 3A illustrates an exemplary embodiment of an operation screen 200 that may be displayed, e.g., when a material curing system is in operation, to show a schedule programmed for a control cycle. A time line 204 is displayed for an environmental control cycle 206 of the controller, which in the present example extends from 0 hours to 160 hours. The controller displays a schedule curve 208 representing a temperature control schedule that includes one or more time segments 212. The schedule curve 208 is identified in a label area 216. Scheduled temperature control value(s) thus are graphically displayed relative to the time line 204 and relative to a vertical temperature axis 220. A current time segment 224, i.e., the scheduled time segment in which the controller is currently operating, is highlighted, e.g., by a “bold” line that may flash intermittently, to visually distinguish the current time segment 224 from the other segments 212. It should be noted generally that a “curve” as referred to herein may include straight portions. In addition to or instead of a curve, other or additional graphic representations suitable for display relative to two axes may also be used. The axes may also be appropriately titled in any one or more of the various displays disclosed herein.

The current date and time are displayed in an area 230. The area 230 may also or alternatively includes a suitable title for what is being graphically displayed. Data pertaining to the schedule curve 208 is also displayed in an area 232, including, e.g., time 234 that has passed since the start of the current scheduled time segment 224, current scheduled temperature 236, and current scheduled relative humidity 238. Additionally, real-time operational data, e.g., obtained through temperature and humidity sensors, is displayed in an area 240, e.g., time 242 remaining in the current time segment 224, current operational temperature 244, and current operational relative humidity 246. A key 250 is programmed to provide an “Edit” function whereby a user may edit the schedule curve 208 by entering set-point value(s) as described below. A key 252 is programmed to provide a “Stop” function whereby the user may stop the curing cycle. It should be noted generally that references in the disclosure and claims to “real-time,” “in real time” and the like include “substantially real-time,” “substantially in real time” and the like, i.e., sufficiently close to real time to prevent time lags, e.g., in updates to displayed data, that a user would notice and interpret as excessive delay.

FIG. 3B illustrates an exemplary embodiment of an operation screen 300 that may be displayed when a HVAC thermostat is in operation. A time line 304 is displayed for an environmental control cycle 308 of the thermostat, which in the present example extends from 0 hours to 24 hours. The thermostat displays a schedule curve 312 representing a temperature control schedule that includes one or more time segments 314. Scheduled temperature control value(s) are graphically displayed relative to the time line 304 and relative to a vertical temperature axis 318. A current time segment 320, i.e., the scheduled time segment 314 in which the thermostat is currently operating, is highlighted, e.g., by a “bold” line that may flash intermittently, to visually distinguish the current segment from the other segments.

The current date and time are displayed in an area 324. The area 324 may also or alternatively includes a suitable title for what is being graphically displayed. Data pertaining to the schedule curve 312 is also displayed in an area 326, including, e.g., time 328 that has passed since the start of the current scheduled time segment 320 and current scheduled temperature 330. Additionally, real-time operational data, e.g., obtained through temperature and humidity sensors, is displayed in an area 334, e.g., time 336 remaining in the current time segment 320, current operational temperature 338, and current relative humidity 340. In the present example embodiment, the thermostat may or may not be configured to control relative humidity, although it is configured to display it. A key 344 is programmed to operate a fan of the HVAC system. A key 348 is programmed to operate a furnace of the HVAC system. Additionally, a key 350 is programmed to provide an “Edit” function whereby a user may edit the schedule curve 312 by entering set-point value(s) as described below.

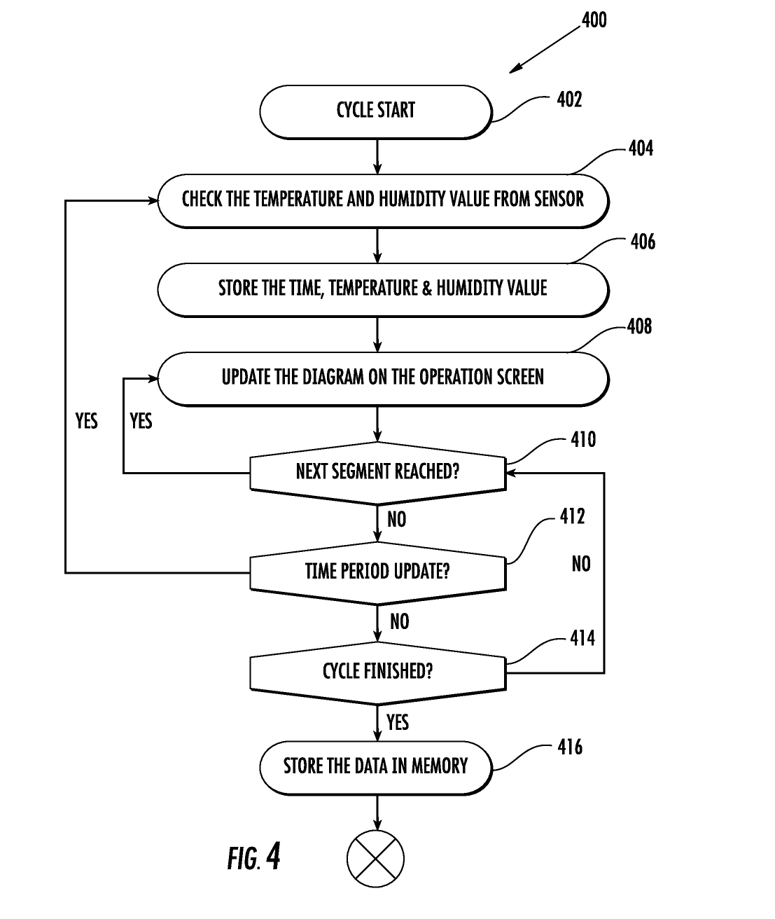

FIG. 4 illustrates a flow diagram of an exemplary embodiment of a method of controlling display of an operation display screen such as the operation screen 200 (FIG. 3A) or operation screen 300 (FIG. 3B). In process 402, an environmental control cycle is begun. In process 404, current operational temperature and/or humidity sensor data is received from temperature and/or humidity sensors. In process 406, the current operational temperature and/or humidity data is stored in memory along with the current time. In process 408, the operation display screen is updated with the current operational data and current time. In process 410, it is determined whether the next time segment in the control schedule has been reached. If yes, then the display screen is updated in process 408 to show a new current time segment, e.g., by removing the highlighting from the display of the time segment that was just completed and by highlighting the display of the next time segment. If the next time segment has not yet been reached, and if process 412 indicates that it is time to obtain an update of sensor data, then control returns to process 404. Otherwise it is determined in process 414 whether the control cycle has ended. If yes, then in process 416 a flag may be appended to the stored data to indicate the end of the cycle. The sensor and time data for the whole cycle is stored in memory, e.g., for future analysis. If the control cycle has not yet ended, then control returns to process 410 to determine whether the next schedule time segment has been reached.

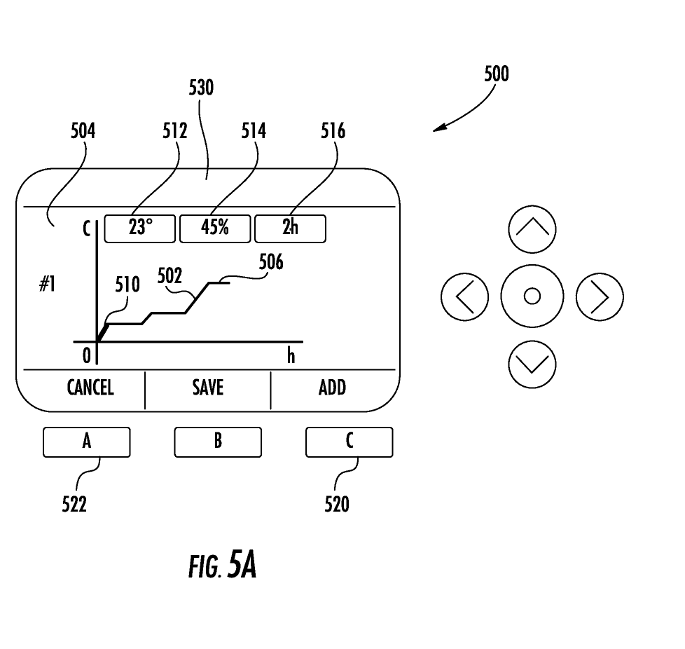

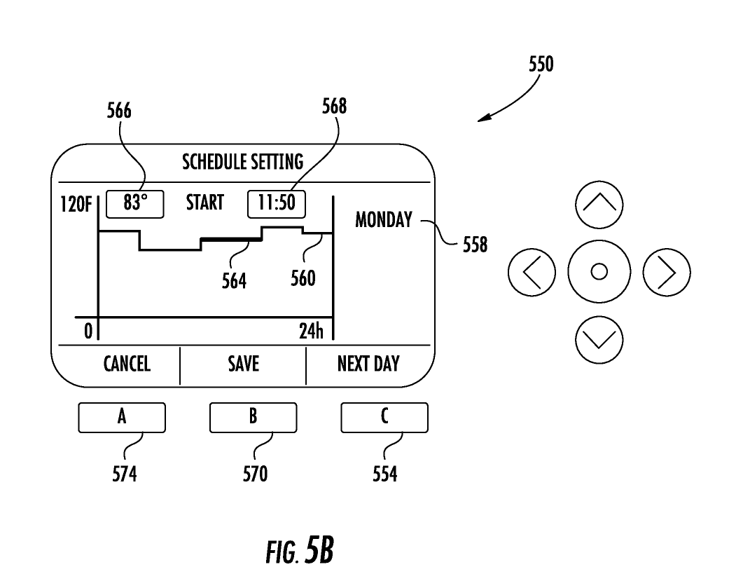

FIG. 5A illustrates an exemplary embodiment of a set-point screen 500 that may be displayed, e.g., when a user of a material curing system activates the “Edit” key or button of an operation screen (e.g., key 250 or 350) to enter and/or revise a control schedule. The schedule curve selected by the user (in the present example screen, a temperature schedule curve 502) is identified in a label area 504. The controller displays at least a portion 506 of the schedule curve 502, beginning with and including a time segment 510 selected by the user. For the selected segment 510, which is highlighted, the set-point screen 500 displays a current scheduled temperature 512, current scheduled relative humidity 514, and length of time 516 scheduled for the selected time segment 510, any or all of which may be selectively changed by the user via the user interface, e.g., as described with reference to FIG. 1. The set-point screen 500 then may display the new value(s) entered by the user. Additionally or alternatively, the user may activate a key 520 to add a time segment to the schedule curve 502. Using, e.g., various controller keys as previously described with reference to FIG. 1, the user may enter new control value(s) for the new time segment. If the user activates a “Cancel” key 522, control returns to the operation screen from which the user selected the set-point screen 500. A suitable title (e.g., Temperature Curve Setting, etc.) for what is being graphically displayed may also be provided, such as at or towards_the top of a display in area 530. The axes may also be appropriately titled in the display.

FIG. 5B illustrates an exemplary embodiment of a set-point screen 550 that may be displayed, e.g., when a user of a HVAC system activates the “Edit” key 350 of, e.g., the thermostat operation screen 300 (FIG. 3B). The user may activate a “Next Day” key 554 to select a day of the week for which the user wishes to change a set-point. The set-point screen 550 displays the selected day of the week 558 and the associated schedule curve 560 and highlights a time segment 564 selected by the user. The set-point screen 550 also displays, e.g., a currently scheduled temperature 566 for the selected time segment 564 and a currently scheduled start time 568 for the selected time segment 564. The user may enter new value(s), which the set-point screen 550 then may display. The user may activate a “Save” key 570 to save the revised schedule in memory. If the user activates a “Cancel” key 574, control returns to the operation screen from which the user selected the set-point screen 550. The set-point screen also includes a title “SCHEDULE SETTING”, although other suitable titles may also be used.

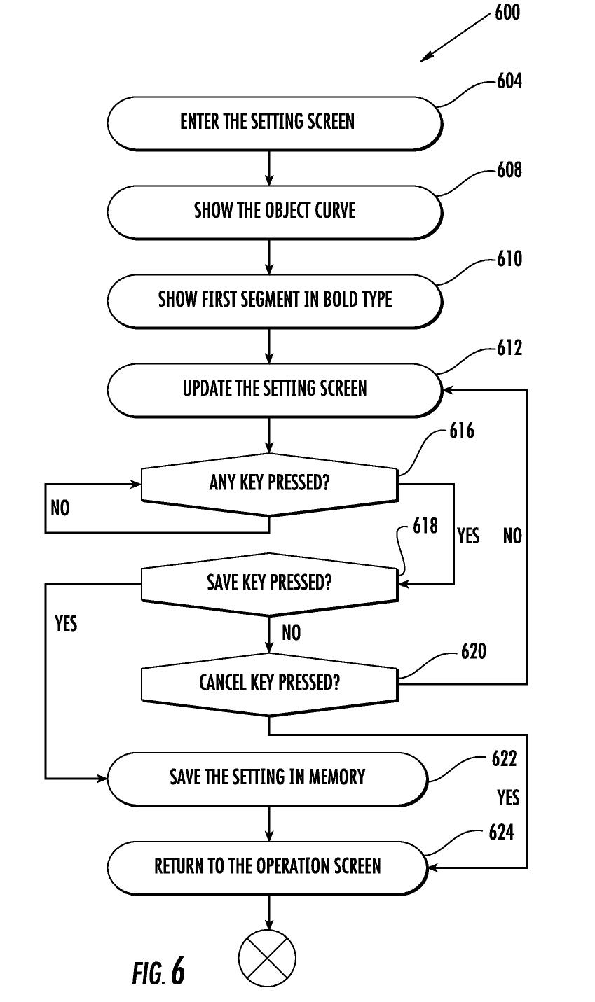

FIG. 6 illustrates a flow diagram 600 of an exemplary embodiment of a method of controlling display of a set-point setting display screen such as the display 500 (FIG. 5A) or display 550 (FIG. 5B). In process 604, a user causes a setting screen, e.g., the set-point screen 500, to be displayed. In process 608, a schedule curve is displayed. In process 610, the controller detects a schedule curve time segment that has been highlighted, e.g., in response to user input. In process 612, the schedule curve is updated to reflect the user's selection. For example, the selected segment may be displayed as the first segment of a portion of the schedule that has not yet been reached in a control cycle for a material curing system. Additionally or alternatively, a thermostat may update the set-point screen to display a currently scheduled temperature for the selected time segment and a currently scheduled start time for the selected time segment, either or both of which may be selectively changed by the user. If in process 616 it is determined that a key has been activated, then in process 618 it is determined whether a “Save” key has been activated. If not, then (unless in process 620 it is determined that the “Cancel” key was activated), the schedule curve is updated in process 612 to reflect the user's selection(s). If the “Save” key is activated, then in process 622 the new settings are saved to memory, and in process 624 control is returned to the operation screen from which the user selected the set-point screen. If in process 620 it is determined that the “Cancel” key was activated, then in process 624 control is returned to the operation screen from which the user selected the set-point screen.

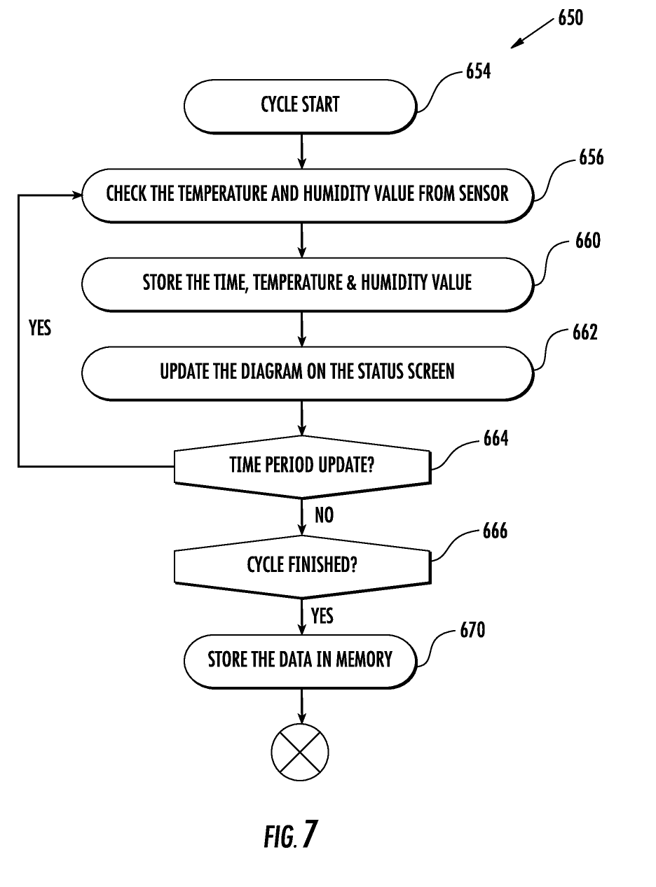

As previously discussed with reference to FIG. 1, when a material curing system controller is in operation, a user may selectively view one or more status display screens, e.g., the status screen 44 indicating temperature and/or the status screen 48 indicating relative humidity. FIG. 7 illustrates a flow diagram 650 of an exemplary embodiment of a method of controlling display of such a status display screen. In process 654, an environmental control cycle is begun. In process 656, temperature and/or humidity sensor data is received and checked. In process 660, the temperature and/or humidity data is stored in memory along with current time data. In process 662, the display screen is updated with the received data. If process 664 indicates that it is time to obtain an update of sensor data, then control returns to process 656. Otherwise, it is determined in process 666 whether the control cycle has ended. If yes, then the sensor and time data for the whole cycle is stored in memory, e.g., for future analysis.

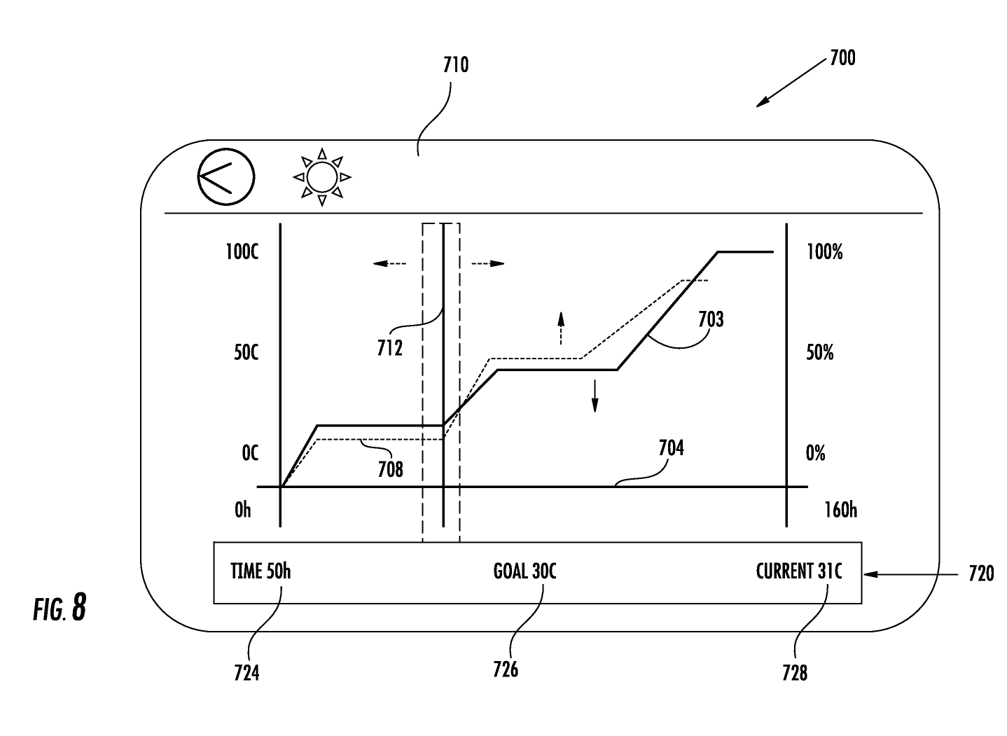

In various embodiments, a user may selectively view a screen that allows the user to compare a programmed control schedule with actual data, e.g., operational data received substantially in real time from one or more sensors. FIG. 8 illustrates one such exemplary screen 700. In the example screen 700, the substantially real-time operational temperature data 58 obtained from the temperature sensors 24 and shown in the example status screen 44 is displayed graphically as control curve or line 703 as, relative to a time line 704, as a curve for comparison with a programmed temperature control schedule or object curve 708 for the control cycle. A title area 710 may be used to identify the display, e.g., curve of temperature contrast, etc. The controller displays and may move a time indicator 712, substantially in real time and/or to the right or left on the screen 700 in response to user input. The time indicator 712 thus is moved relative to the time line 704, schedule or object curve 708, and control curve or graphed line 703 representing the operational data 58. An information area 720 includes the time 724 (50 hours), the goal or the scheduled or object temperature 726 (30 degrees Celsius corresponding to the location of the time indicator 712), and the current operational temperature 728 (31 degrees Celsius). Thus, a user can see and compare trends of the programmed schedule control values with trends of substantially real-time operational data.

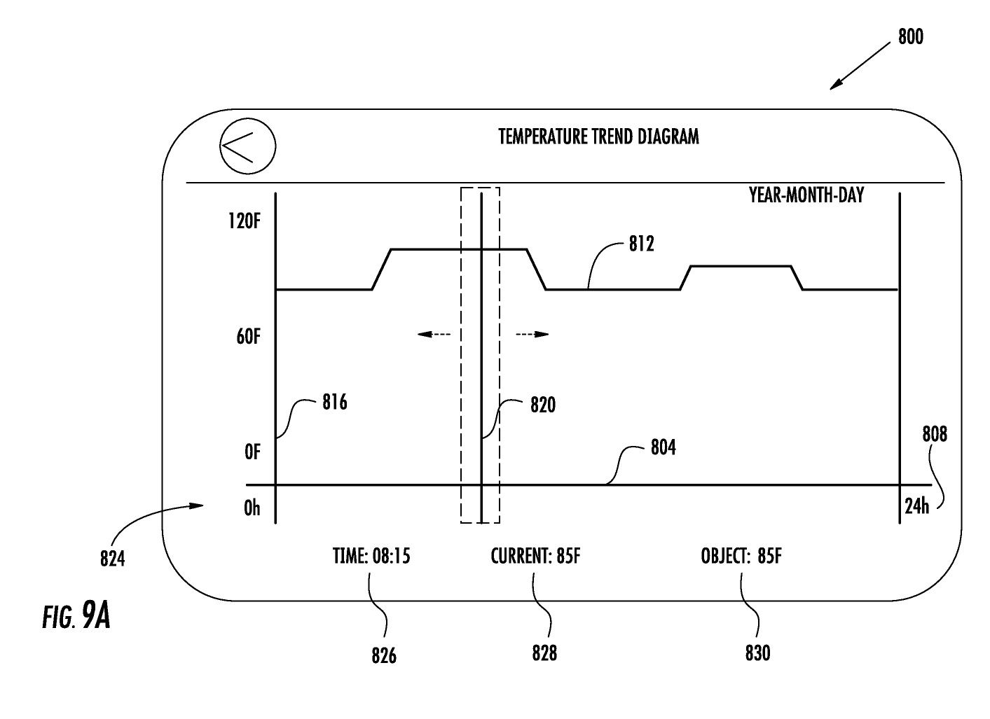

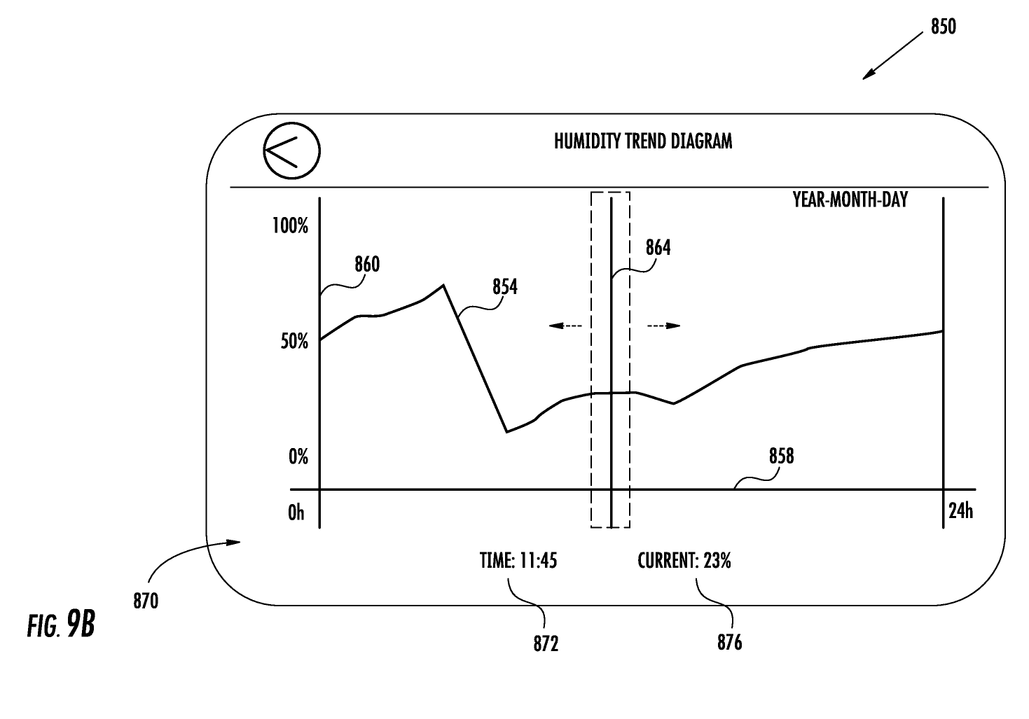

In some exemplary aspects of the disclosure, a HVAC system thermostat may provide status comparison screens. FIG. 9A illustrates an example status comparison screen 800 showing temperature for a HVAC system. The screen 800 includes a time line 804 for a 24-hour control cycle. In various HVAC systems, a curve of operational temperatures for a control cycle may typically exhibit the same or similar values as those of the schedule curve for that cycle. Accordingly, in various exemplary thermostat embodiments, a curve of scheduled temperatures may or may not be displayed. In the example screen 800, a curve 812 represents operational data received, e.g., from temperature sensor(s) and displayed substantially in real time. A left-hand axis 816 indicates a range of temperature values. A time indicator 820 is displayed and may be moved relative to a time line 804 as previously discussed with reference to FIG. 8. An information area 824 includes current time 826, operational temperature 828, and scheduled temperature 830 corresponding to the location of the time indicator 820. Thus, a user can see and compare trends of the programmed schedule control values with trends of substantially real-time operational data.

FIG. 9B illustrates an example screen 850 that displays a humidity trend diagram for a HVAC system, which may not provide humidity control. A curve 854 representing operational data from humidity sensor(s) is graphically displayed relative to a time line 858. A left-hand axis 860 indicates relative humidity values. A time indicator 864 is displayed and may be moved relative to the time line 858 and curve 854, substantially in real time and/or in response to user input, as previously described. An information area 870 includes time 872 and relative humidity 876 corresponding to the location of the time indicator 864.

Exemplary embodiments may include a temporal indicator to highlight the current status relative to the displayed timeline. In an exemplary embodiment, there is a display (e.g., dot matrix display, etc.) for a tobacco curing controller which shows the current temperature and relative humidity for a programmed tobacco curing cycle, as measured or compared with the programmed curing profile. In this example, the display is configured with the capability to display a real time graph of the actual curing process overlaid on the desired or programmed process. Other disclosed exemplary embodiments relate to other environmental controllers such as HVAC controls, e.g., a thermostat with a dot matrix display, etc.

In exemplary embodiments, an environmental controller (e.g., thermostat, tobacco curing control, etc.) includes a display device that is operable for displaying a single horizontal axis for time and two vertical axes, one for temperature and another for relative humidity. The display device also displays a moving vertical indicator that highlights the current time on the time axis. For a tobacco curing control, the display device may be configured to display the programmed curing schedule for the tobacco leaves, including the total cycle time for the curing process (as listed on the horizontal axis), the current temperature (both programmed and actual), and the current relative humidity (both programmed and actual). All three controlled parameters may be displayed on a single screen in real time as indicated by the vertical traveling marker. The real time values for temperature, time, and relative humidity may be listed along the bottom of the screen, below the time axis. The display device may show the programmed curing cycle for the chosen tobacco leaf, with the real time vertical marker visually indicating the progress of the curing schedule, and the actual values listed below the horizontal time axis. For a thermostat embodiment, the thermostat's display device may display the former, current, and future selected temperature profile. In addition, if the HVAC system was equipped to add or remove humidity, the display device might also indicate whether the system was controlling to temperature, or relative humidity.

The foregoing exemplary embodiments make it possible for users to view the current status and trends of environmental control cycles. The foregoing display screens can be updated substantially in real time, thereby allowing the user to modify a control schedule and substantially immediately see the modified schedule. In contrast, when currently available environmental controllers are in operation, they typically do not show graphically the passage of real time relative to the current status of a control cycle. When a user enters or modifies the value of a set-point, there is no diagram to show the whole schedule to the user. Most environmental controllers for material curing applications do not store data, and so a user can find it hard to analyze the quality of a product that is being cured. Even where data is stored, it is typically displayed only in numeric form not graphically.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (the disclosure of a first value and a second value for a given parameter can be interpreted as disclosing that any value between the first and second values could also be employed for the given parameter). Similarly, it is envisioned that disclosure of two or more ranges of values for a parameter (whether such ranges are nested, overlapping or distinct) subsume all possible combination of ranges for the value that might be claimed using endpoints of the disclosed ranges. In addition, disclosure of ranges includes disclosure of all distinct values and further divided ranges within the entire range.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally”, “about”, and “substantially” may be used herein to mean within manufacturing tolerances.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed herein could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An environmental controller comprising at least one processor and memory configured to:
in an environmental control cycle of the controller, receive, in substantially real time, sensor data indicating operational values of at least one parameter controlled through the controller based on a control schedule for the control cycle; and
graphically display, in substantially real time, the operational values and the control schedule relative to a time line for the control cycle.

2. The environmental controller of claim 1, wherein the at least one processor and memory are further configured to graphically display and move a time indicator in substantially real time relative to the time line.

3. The environmental controller of claim 2, wherein the at least one processor and memory are configured to display, on a single display screen, a current temperature or a current humidity, a scheduled temperature or scheduled humidity, in substantially real time as indicated by the time indicator.

4. The environmental controller of claim 2, wherein the at least one processor and memory are further configured to:
graphically display and move the time indicator to a user-selected location relative to the time line; and
display at least one of a control value of the control schedule and an operational value corresponding to the user-selected location.

5. The environmental controller of claim 1, wherein the at least one parameter includes temperature and/or humidity.

6. The environmental controller of claim 1, comprising a thermostat for a heating, ventilation and air conditioning system and/or a controller for a material curing system.

7. An environmental controller comprising at least one processor and memory configured to:
in an environmental control cycle of the controller, receive, in substantially real time, sensor data indicating operational values of at least one parameter controlled through the controller;
graphically display, in substantially real time, the operational values relative to a time line for the control cycle; and
graphically display and move a time indicator along the time line substantially in real time to indicate time relative to a start of the control cycle.

8. The environmental controller of claim 7, wherein the at least one processor and memory are further configured to graphically display, in substantially real time, a graph of a control schedule for the control cycle relative to the time line and the operational values.

9. The environmental controller of claim 8, wherein the at least one processor and memory are configured to display, on a single display screen, a current temperature or a current humidity, a scheduled temperature or scheduled humidity, in substantially real time as indicated by the time indicator.

10. The environmental controller of claim 7, wherein the at least one processor and memory are further configured to:
graphically display and move the time indicator to a user-selected location relative to the time line; and
display at least one of an operational value and a control schedule value corresponding to the user-selected location.

11. The environmental controller of claim 7, wherein the at least one parameter includes temperature and/or humidity.

12. The environmental controller of claim 7, comprising a thermostat for a heating, ventilation and air conditioning system and/or a controller for a material curing system.

13. An environmental controller comprising at least one processor and memory configured to:
graphically display a time line for an environmental control cycle of the controller; and
based on user input, selectively display, graphically and relative to the time line: (a) a control schedule for controlling at least one parameter in accordance with one or more control values for the control cycle, and/or (b) substantially real-time operational values of the at least one parameter.

14. The environmental controller of claim 13, comprising a thermostat for a heating, ventilation and air conditioning system and/or a controller for a material curing system.

15. The environmental controller of claim 13, wherein the at least one processor and memory are configured to graphically display and move a time indicator substantially in real time relative to the time line.

16. The environmental controller of claim 15, wherein the at least one processor and memory are configured to display, on a single display screen, a current temperature or a current humidity, a scheduled temperature or scheduled humidity, in substantially real time as indicated by the time indicator.

17. The environmental controller of claim 13, wherein the at least one parameter includes temperature and/or humidity.

18. A method comprising:
receiving, in substantially real time, sensor data indicating operational values of at least one parameter based on a control schedule for an environmental control cycle of an environmental controller;
graphically displaying, in substantially real time, the operational values and the control schedule relative to a time line for the control cycle; and
graphically displaying and moving a time indicator along the time line substantially in real time to indicate time relative to a start of the control cycle.

19. The method of claim 18, further comprising:
graphically displaying and moving the time indicator to a user-selected location relative to the time line; and
displaying at least one of a control value of the control schedule and an operational value corresponding to the user-selected location.

20. The method of claim 18, wherein:
the method includes displaying, on a single display screen, a current temperature or a current humidity, a scheduled temperature or scheduled humidity, in substantially real time as indicated by the time indicator; and/or
the at least one parameter includes temperature and/or humidity.
